(19) United States
(12) Patent Application Publication
(10) Pub. No.: US 2014/0242419 A1
(43) Pub. Date: Aug. 28, 2014

(54) PERPENDICULAR RECORDING MEDIUM FOR HARD DISK DRIVES

(71) Applicant: SHOWA DENKO HD SINGAPORE PTE LTD., Singapore (SG)

(72) Inventors: Amarendra SINGH, Singapore (SG); Ben Beng Beng LIM, Singapore (SG); Hiroshi KANAZAWA, Singapore (SG); Voon Siang KHOANG, Singapore (SG)

(73) Assignee: SHOWA DENKO HD SINGAPORE PTE LTD., Singapore (SG)

(21) Appl. No.: 14/187,831

(22) Filed: Feb. 24, 2014

(30) Foreign Application Priority Data
Feb. 28, 2013 (SG) 201301583-9

(51) Int. Cl. G11B 5/738

(52) U.S. Cl. CPC G11B 5/738
USPC 428/827; 428/831; 428/831.2

(57) ABSTRACT

There is provided a perpendicular recording medium comprising: a substrate with a seed layer formed thereon; a soft underlayer formed on the seed layer; an orientation control layer formed on the soft underlayer; an intermediate layer formed on the orientation control layer; a flash layer formed on the intermediate layer, the flash layer comprising an oxide; and a recording layer formed on the flash layer.

### FIELD

The present invention relates to a perpendicular recording medium which has particular application in hard disk drives.

### BACKGROUND

Perpendicular recording media are widely used in various applications, particularly in the computer industry. In perpendicular magnetic recording medium, bits are formed by a magnetic field in a direction that is perpendicular to the plane of a perpendicular recording medium having perpendicular magnetizing anisotropy with typically a layer of magnetic material on a suitable substrate. Very high linear recording densities are achieved by utilizing a “single-pole” magnetic transducer or “head” with such perpendicular magnetic media. In order to support increase in the capacity of magnetic disk drives, continuous effort is needed for further improvement in recording density. In order to increase recording density, perpendicular recording medium with (i) high thermal stability, (ii) lower noise, and (iii) reduced head to magnetic spacing are necessary.

As technology improves, perpendicular recording moves towards higher data rates that require higher operating frequencies. Writability and signal strength will decrease significantly as frequency increases, thus it is important to improve high frequency response especially for high data rate programs.

### SUMMARY OF INVENTION

The present invention represents several techniques to improve the response in the high frequency region. Providing good segregation through adopting an oxide-rich magnetic layer and high pressure interlayers can help to provide good segregation in the perpendicular magnetic recording medium.

In view of the foregoing, there is provided, in a first aspect, a perpendicular recording medium for application in hard disk drives. The perpendicular recording medium may comprise a seed layer formed on a substrate, a soft under layer formed on the seed layer, followed by an orientation control layer, an intermediate layer, and a recording layer. The perpendicular recording medium also includes a flash layer which comprises an oxide-rich magnetic layer between the intermediate layer and the recording layer. This flash layer provides a good segregation platform for subsequent magnetic layers formed on top of it. The intermediate layer may comprise Ru. Thickness and pressure of the intermediate interlayer also affects the overall segregation of the recording media.

Other features and advantages of the invention will be apparent from the following detailed description and from the appended claims.

There is provided a perpendicular recording medium comprising: a substrate with a seed layer formed thereon; a soft underlayer formed on the seed layer; an orientation control layer formed on the soft underlayer; an intermediate layer formed on the orientation control layer; a flash layer formed on the intermediate layer, the flash layer comprising an oxide; and a recording layer formed on the flash layer. It is advantageous that the oxide in the flash layer gives rise to a boundary having a segregation effect to effect exchange coupling between grains in the recording layer.

A volume of the oxide in the flash layer is about 30 to 50%, a thickness of the flash layer is between about 0.5 nm and about 1 nm, and a pressure at the flash layer is between about 5 and about 10 Pa. It is preferable that the flash layer is configured such that increased thickness of the flash layer improves high frequency response of the perpendicular recording medium. It is also preferable that the flash layer is configured such that increased pressure at the flash layer improves high frequency response of the perpendicular recording medium. Preferably, the flash layer is configured such that increased thickness of the flash layer lowers cluster size in the perpendicular recording medium. It is preferable that the flash layer is configured such that increased pressure at the flash layer lowers cluster size in the perpendicular recording medium.

A thickness of the intermediate layer is between about 7 nm and about 10 nm and a pressure at the intermediate layer is between about 10 and about 16 Pa. Preferably, the intermediate layer is configured such that increased pressure at the intermediate layer improves high frequency response of the perpendicular recording medium. It is preferable that the intermediate layer is configured such that increased pressure at the intermediate layer lowers cluster size.

Preferably, the flash layer comprises: a first magnetic layer having a high Ku and grain boundaries thickness ranging from about 1 to about 2 nm; and a second magnetic layer formed on the first magnetic layer, the second magnetic layer having a lower Ku that the first magnetic layer and having thinner grain boundaries than the first magnetic layer. Preferably, the flash layer is formed on the intermediate layer of the perpendicular recording medium. The pressure at the first and second magnetic layers is between about 3 Pa to about 7 Pa.

### DRAWINGS

The present invention will now be described by way of example with reference to the accompanying drawings in which:

FIG. 1 shows a schematic view of the perpendicular recording medium of the present invention;

FIG. 2 shows a variation of Delta ROW with flash and interlayer thickness and pressure, according to an embodiment of the present invention; and

FIG. 3 shows a variation of cluster size (Dn) with switching distribution (dHc/Hc), according to a further embodiment of the present invention.

### DESCRIPTION

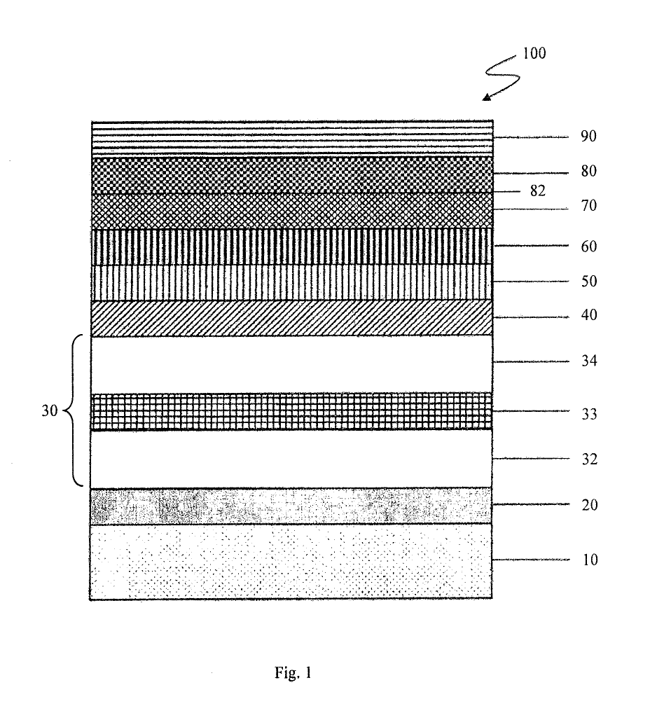

Exemplary embodiments of a perpendicular recording medium 100 according to the present invention will be described with reference to FIGS. 1 to 3 below.

As shown in FIG. 1, a first embodiment of the structure of the perpendicular recording medium 100 of the present invention comprises a seed layer 20 which is formed on a substrate 10. A soft underlayer 30 is formed on the seed layer 20. The soft under layer 30 may comprise a first soft underlayer 32 and second soft underlayer 34, with an anti-friction coating (AFC) layer 33 provided in between the first 32 and second 34 soft underlayers. It should be appreciated that the AFC layer 33 can be optional. An orientation control layer 40 is formed on the soft underlayer 30. An intermediate layer 50 is formed on the orientation control layer 40. A flash layer 60 is formed on the intermediate layer 50. Furthermore, a recording layer 70, a protective layer 80, and a lubricant layer 90 are respectively formed subsequently on the flash layer 60.

Preferably, the substrate 10 is made of aluminium alloy. In other embodiments, the substrate 10 may be made of materials such as glass, silicon, or silicon carbide. Preferably, the average surface roughness of the substrate 10 should not be greater than about 0.3 nm and should not be less than about 0.1 nm.

In the preferred embodiment, the seed layer 20 comprises CrTi with Ti content of 40 to 60%. The seed layer 20 may have either an amorphous or a nano-crystalline structure. The seed layer 20 helps to provide a smoother surface for the soft underlayer 30 and results in better Co-crystal orientation of the grains in the perpendicular recording medium structure 100. The seed layer 20 also reduces the roughness (Ra) of the perpendicular recording medium 100, thereby helping to decrease the Head Media Spacing. This also results in better scratch resistance.

The first and second soft underlayers 32, 34 preferably comprise CoFe with a Co base alloy, and, preferably, with one or more additives selected from the group consisting of: Ta, Nb, Zr, Si, B, C, Al, C with 0 to 10 at %. An amorphous crystal structure is preferable for the soft underlayer 30. An amorphous soft underlayer 30 gives better crystal orientation of grains in the perpendicular recording medium structure 100. Preferably, the thickness of the soft underlayer 30 should not be less than about 10 nm, and should not exceed about 70 nm.

The orientation control layer 40 comprises Ni-alloy, Pt, Ta or Pd-alloy. The orientation control layer 40 provides better crystal growth and orientation of grains in the recording layer 70. The thickness of the orientation control layer 40 should not be less than about 1 nm and should be greater than about 15 nm. Thinner orientation control layers do not provide sufficient crystal growth and orientation of grains in the perpendicular recording medium 100. However, thicker orientation control layers increase the head to soft underlayer spacing, thereby resulting in poor writability.

The intermediate layer 50 helps to control (i) grain size and distribution of grains in the recording layer 70; (ii) crystal orientation of grains in the recording layer 70; and (iii) facilitates better segregation of grains in the recording layer 70. Intermediate layer 50 comprises Ru or Ru-alloy. Preferably, the thickness of the intermediate layer 50 should not be less than about 10 nm, and should not be greater than about 40 nm.

The flash layer 60 consists of Co, Ru, Pt, and an oxide. The oxide volume preferably ranges from 30 to 50%. The flash layer 60 provides a clear boundary due to the nature of the oxide. This boundary provides a segregation effect to effect exchange coupling between grains in the recording layer 70. In an embodiment of the present invention, the thickness of flash layer 60 should be between about 0.5 nm and about 1 nm, in order to maintain sufficient signal output, signal-to-noise ratio (SNR) and overwrite characteristics.

Preferably, the flash layer 60 is formed of two magnetic layers: a first magnetic layer having a high Ku and grain boundaries thickness ranging from about 1 to about 2 nm, and a second magnetic layer formed on the first magnetic layer. The second magnetic layer has a lower Ku than the first magnetic layer and has thinner grain boundaries than that of the first magnetic layer. Pressure at the first and second magnetic layers is preferably between about 3 Pa to about 7 Pa.

The recording layer 70 preferably comprises Co, Cr, Pt, and an oxide, and has an easy axis orientation perpendicular to the film normal. It further preferably comprises at least one additive selected from the group consisting of: B, Zr, W, Ti, Ta, Ru, for further improving the SNR. The recording layer 70 preferably comprises multiple granular recording layers, an exchange layer, and an upper continuous recording layer. The thickness of the recording layer 70 is preferably between about 20 nm and about 70 nm, in order to maintain sufficient signal output, signal-to-noise ratio (SNR) and overwrite characteristics.

The protective layer 80 helps to prevent damage to the surface 82 of the perpendicular recording medium 100, and also helps to protect it from corrosion. Preferably, the protective layer 80 includes one of the following materials: C, Ru, or SiO₂ and the thickness of the protective layer 80 should not be less than about 1 nm, and should not be greater than about 5 nm.

The lubricant layer 90 preferably comprises one or more of the following exemplary materials: perfluoropolyether, a fluorinated alcohol, and fluorinated carboxylic acid.

The perpendicular recording medium 100 according to the present invention may be fabricated by DC magnetron sputtering of the various layers 10 to 70, except the protective layer 80. The protective layer 80 may be formed by Chemical Vapour Deposition (CVD) where a vacuum level of up to 10⁻⁵ Pa is maintained inside the CVD vacuum chamber.

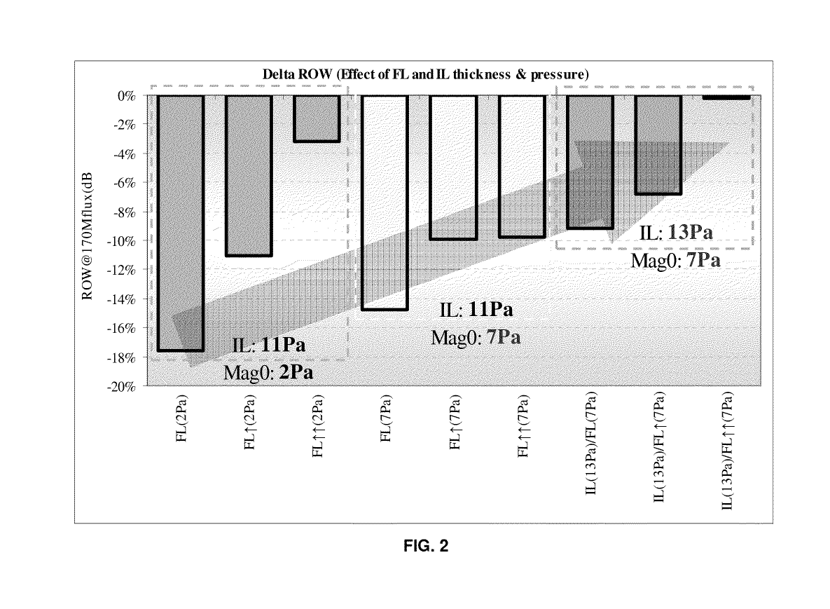

As described above, in the perpendicular recording medium 100, the flash layer 60 comprises Co, Ru, Pt, and an oxide, and provides a clear boundary due to the nature of the oxide. This boundary provides a segregation effect that effects exchange coupling between grains in the recording layer 70. FIG. 2 illustrates the effect of the flash layer thickness, the pressure of the flash layer 70 and the pressure of the intermediate layer 50 on Delta Reverse Overwrite (ROW), where Delta ROW is computed based on difference of ROW between high frequency (2500 Mflux) and Nominal frequency (170 Mflux). As can be seen in FIG. 2, increasing flash layer thickness, increasing flash layer pressure and increasing intermediate layer pressure consequently enhances segregation, which in turn improves Delta ROW, leading to an improvement in high frequency response of the perpendicular recording medium 100.

Accordingly, High Frequency Writability (HFW) Performance for depicting a trend at high frequency may be estimated by equation (1) below:

[High Frequency ROW−Nominal Frequency ROW]/Nominal Frequency ROW×100% (1)

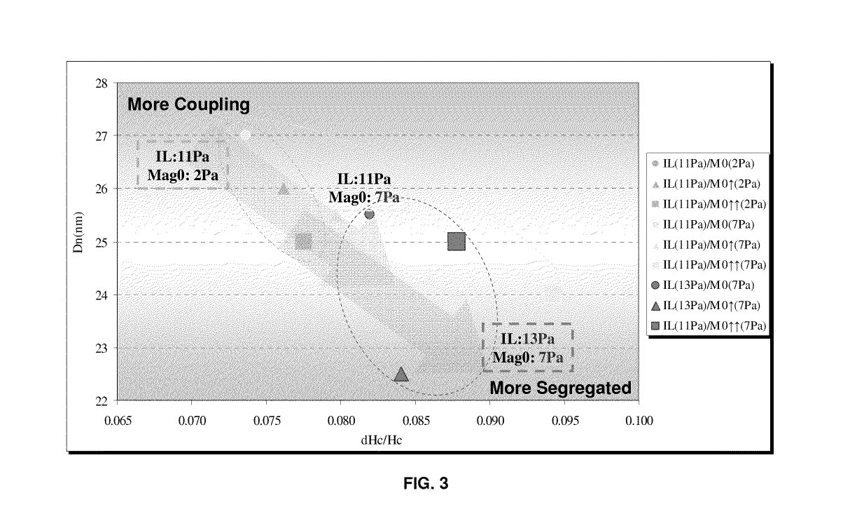

FIG. 3 shows the relationship between cluster size (Dn) and switching distribution (dHc/Hc) on the samples used to obtain the results shown in FIG. 2. It can be seen that samples with more segregation, e.g. a thicker flash layer 60 and higher flash layer pressure, exhibit smaller cluster size with poorer switching distribution. This also indicates that to improve high frequency response of the perpendicular recording medium 100, moving towards smaller cluster size by improving segregation through flash layer 60 and intermediate layer 50 thicknesses and pressure is critical.

It will of course be understood that the present invention has been described above purely by way of example and modifications of detail can be made within the scope of the invention.

1. A perpendicular recording medium comprising:
a substrate with a seed layer formed thereon;
a soft underlayer formed on the seed layer;
an orientation control layer formed on the soft underlayer;
an intermediate layer formed on the orientation control layer;
a flash layer formed on the intermediate layer, the flash layer comprising an oxide; and
a recording layer formed on the flash layer, the oxide in the flash layer giving rise to a boundary having a segregation effect to effect exchange coupling between grains in the recording layer.

2. The perpendicular recording medium of claim 1, wherein volume of the oxide in the flash layer is about 30 to 50%.

3. The perpendicular recording medium of claim 1, wherein thickness of the flash layer is between about 0.5 nm and about 1 nm.

4. The perpendicular recording medium of claim 1, wherein pressure at the flash layer is between about 5 and about 10 Pa.

5. The perpendicular recording medium of claim 1, wherein thickness of the intermediate layer is between about 7 nm and about 10 nm.

6. The perpendicular recording medium of claim 1, wherein pressure at the intermediate layer is between about 10 and about 16 Pa.

7. The perpendicular recording medium of claim 1, wherein the flash layer is configured such that increased thickness of the flash layer improves high frequency response of the perpendicular recording medium.

8. The perpendicular recording medium of claim 1, wherein the flash layer is configured such that increased pressure at the flash layer improves high frequency response of the perpendicular recording medium.

9. The perpendicular recording medium of claim 1, wherein the intermediate layer is configured such that increased pressure at the intermediate layer improves high frequency response of the perpendicular recording medium.

10. The perpendicular recording medium of claim 1, wherein the flash layer is configured such that increased thickness of the flash layer lowers cluster size in the perpendicular recording medium.

11. The perpendicular recording medium of claim 1, wherein the flash layer is configured such that increased pressure at the flash layer lowers cluster size in the perpendicular recording medium.

12. The perpendicular recording medium of claim 1, wherein the intermediate layer is configured such that increased pressure at the intermediate layer lowers cluster size.

13. The perpendicular recording medium of claim 1 wherein the flash layer comprises:
a first magnetic layer having a high Ku and grain boundaries thickness ranging from about 1 to about 2 nm;
a second magnetic layer formed on the first magnetic layer, the second magnetic layer having a lower Ku that the first magnetic layer and having thinner grain boundaries than the first magnetic layer,
wherein the flash layer is formed on the intermediate layer of the perpendicular recording medium.

14. The perpendicular recording medium of claim 13, wherein pressure at the first and second magnetic layers is between about 3 Pa to about 7 Pa.
